(19) United States
(12) Patent Application Publication
(10) Pub. No.: US 2021/0304457 A1
(43) Pub. Date: Sep. 30, 2021

(54) USING NEURAL NETWORKS TO ESTIMATE MOTION VECTORS FOR MOTION CORRECTED PET IMAGE RECONSTRUCTION

(71) Applicants: The Regents of the University of California, Oakland, CA (US); CANON MEDICAL SYSTEMS CORPORATION, Otawara-shi (JP)

(72) Inventors: Jinyi QI, Oakland, CA (US); Tiantian LI, Oakland, CA (US); Zhaoheng XIE, Oakland, CA (US); Wenyuan QI, Vernon Hills, IL (US); Li YANG, Vernon Hills, IL (US); Chung CHAN, Vernon Hills, IL (US); Evren ASMA, Vernon Hills, IL (US)

(73) Assignees: The Regents of the University of California, Oakland, CA (US); CANON MEDICAL SYSTEMS CORPORATION, Otawara-shi (JP)

(21) Appl. No.: 17/180,182

(22) Filed: Feb. 19, 2021

Related U.S. Application Data
(60) Provisional application No. 63/003,238, filed on Mar. 31, 2020.

(51) Int. Cl. G06T 11/00; G06T 7/246

(52) U.S. Cl. CPC G06T 11/005; G06T 7/248; G06T 2207/20084; G06T 2207/10104; G06T 2207/20081; G06T 2211/424

(57) ABSTRACT

To reduce the effect(s) caused by patient breathing and movement during PET data acquisition, an unsupervised non-rigid image registration framework using deep learning is used to produce motion vectors for motion correction. In one embodiment, a differentiable spatial transformer layer is used to warp the moving image to the fixed image and use a stacked structure for deformation field refinement. Estimated deformation fields can be incorporated into an iterative image reconstruction process to perform motion compensated PET image reconstruction. The described method and system, using simulation and clinical data, provide reduced error compared to at least one iterative image registration process.

### CROSS REFERENCE TO CO-PENDING APPLICATION

This application claims priority to U.S. Provisional Patent Application No. 63/003,238, filed Mar. 31, 2020, the contents of which are incorporated herein by reference.

### FIELD OF THE INVENTION

The present invention is directed to a method and system for providing improved motion compensation in images (e.g., medical images), and, in one embodiment, to a method and system for using a deep learning neural network based system to provide motion correction for PET data.

### BACKGROUND

Artifacts caused by patient breathing and movement during positron emission tomography (PET) data acquisition affect image quality and lead to underestimation of tumor activity and overestimation of tumor volume. See, e.g., [Kalantari 2016]: (Kalantari F, Li T, Jin M and Wang J; 2016; Respiratory motion correction in 4D-PET by simultaneous motion estimation and image reconstruction (SMEIR) Phys Med Biol 61 5639). Lesion detectability also suffers from motion blurring since small lesions are likely to remain undetected, which may result in misdiagnosis. See, e.g., [Nehmeh 2002b]: (Nehmeh S A, Erdi Y E, Ling C C, Rosenzweig K E, Schoder H, Larson S M, Macapinlac H A, 384 Squire O D and Humm J L; 2002; Effect of respiratory gating on quantifying PET images of lung cancer J Nucl Med 43 876-81). This makes motion corrected image reconstruction valuable for PET imaging. Respiratory gating has been used to gate list-mode PET data into multiple bins over a respiratory cycle based on either an external hardware or a data-driven self-gating technique. See, e.g., (1) [Chan 2017]: (Chan C, Onofrey J, Jian Y, Germino M, Papademetris X, Carson R E and Liu C 2017 Non-rigid event-by-event continuous respiratory motion compensated list-mode reconstruction for PET IEEE transactions on medical imaging 37 504-15), and (2) [Büther 2009]: (Büther F, Dawood M, Stegger L, Wübbeling F, Schäfers M, Schober 0 and Schäfers K P 2009 List mode-driven cardiac and respiratory gating in pet J Nucl Med 50 674-81). Within each time bin, the motion blurring is assumed to be negligible. See, e.g., [Nehmeh 2002a]: (Nehmeh S, Erdi Y, Ling C, Rosenzweig K, Squire 0, Braban L, Ford E, Sidhu K, Mageras G and Larson S 2002a Effect of respiratory gating on reducing lung motion artifacts in PET imaging of lung cancer Med Phys 29 366-71). The motion-frozen images can be reconstructed gate-by-gate using the data from each bin. However, gated PET reconstructed images suffer from low signal-to-noise ratio since the count level is low in each gate. Furthermore, non-rigid registration of respiratory-gated PET images can reduce motion artifacts and preserve count statistics, but it is time consuming.

All motion corrected image reconstruction techniques, whether they perform motion correction post-reconstruction or during the reconstruction, require motion vectors. These motion vectors describe how each voxel moves from one gate to another. Motion vectors are typically estimated by reconstructing the individual gates and then registering each gate to the reference gate. Since image registration techniques deform one gate to another, the output of a registration describes how one gate should be deformed to obtain another gate and these deformation fields form the motion vectors of interest. Image registration techniques only deal with transforming a gated image such that it looks like another gated image as closely as possible. There is no requirement of generating physically realistic motion vectors. As a result, an image registration technique can produce physically unrealistic deformation fields where voxels cross each other or move unrealistically long distances or get compressed beyond physical limits. The drawbacks of image registration techniques are dealt with by using techniques such as regularizing deformation fields and/or applying the techniques in a multi-resolution framework. Even when image registration techniques are made to produce realistic motion vectors, they are computationally intensive as each image registration corresponds to solving an optimization problem. Furthermore, if the reference gate is changed, a whole new set of registration processes need to be performed.

One of the widely used methods to reduce noise is to utilize events from all gates by incorporating a motion model into the reconstruction procedure. While the motion information can be obtained from high resolution anatomical images, e.g. computed tomography (CT) (See, e.g.,[Lamare 2007]: (Lamare F, Carbayo M L, Cresson T, Kontaxakis G, Santos A, Le Rest C C, Reader A and Visvikis D 2007 List-mode-based reconstruction for respiratory motion correction in PET using non-rigid body transformations Phys Med Biol 52 5187)) or magnetic resonance imaging (MM) (See, e.g., [Fayad 2015]: (Fayad H, Schmidt H, Wuerslin C and Visvikis D 2015 Reconstruction-incorporated respiratory motion correction in clinical simultaneous PET/MR imaging for oncology applications J Nucl Med 56 884-9)), utilizing other image modalities always leads to multiple issues, such as extra time and cost, image co-registration, extra radiation dose from the CT scan and synchronization issues between the scanners. Accurate non-rigid registration based on gated PET images themselves is challenging due to their high noise levels and is also time consuming. Recently, deep learning techniques have provided new approaches for either supervised image registration (See, e.g., (1) [Sokooti 2017]: (Sokooti H, de Vos B, Berendsen F, Lelieveldt B P, Išgum I and Staring M 2017 3D Convolutional Neural Networks Image Registration Based on Efficient Supervised Learning from Artificial Deformations International Conference on Medical Image Computing and Computer-Assisted Intervention 232-9), and (2) [Krebs]: (Krebs J, Mansi T, Delingette H, Zhang L, Ghesu F C, Miao S, Maier A K, Ayache N, Liao R and Kamen A 2017 Robust non-rigid registration through agent-based action learning International Conference on Medical Image Computing and Computer-Assisted Intervention 344-52)) or unsupervised image registration (See, e.g., (1) [Bakakrishnan 2018]: (Balakrishnan G, Zhao A, Sabuncu M R, Guttag J and Dalca A V 2018 An Unsupervised Learning Model for Deformable Medical Image Registration Proceedings of the IEEE Conference on Computer Vision and Pattern Recognition 9252-60), (2) [Li and Fan 2018]: (Li H and Fan Y 2018 IEEE 15th International Symposium on Biomedical Imaging 1075-8), and (3) [Lau 2019]: (Lau T, Luo J, Zhao S, Chang E I and Xu Y 2019 Unsupervised 3D End-to-End Medical Image Registration with Volume Tweening Network arXiv preprint arXiv:1902.05020)).

One possible supervised convolutional neural network (CNN) architecture may aim to find a mapping between the learned image features and the deformation field that registers the training image pairs. Training these kinds of networks relies on the knowledge of the true deformation field; therefore, training pairs were usually simulated by warping existing images with artificially generated deformation fields. See, e.g., (1) [Sokooti 2017] and (2) [Krebs 2017]. For real data, the ground truth deformation field is usually substituted with the estimate from an iterative image registration algorithm. See, e.g., [Liao 2017]: (Liao R, Miao S, de Tournemire P, Grbic S, Kamen A, Mansi T and Comaniciu D 2017 An artificial agent for robust image registration Proceedings of the Thirty-First AAAI Conference on Artificial Intelligence). However, in medical imaging, an accurate ground-truth deformation between image pairs may be difficult to obtain which may limit the application of supervised learning.

A spatial transformer network (STN) (See, e.g., [Jaderberg 2015]: (Jaderberg M, Simonyan K and Zisserman A 2015 Spatial transformer networks Advances in neural information processing systems 2017-25)) has been proposed to warp images, which enables neural networks to perform unsupervised learning without knowing the true deformation field. The combination of stacked CNNs and STNs have been proposed recently to learn the image feature representations and a mapping between the image features and the deformation field at the same time (See, e.g. (1) [Balakrishnan 2018], (2) [Li and Fan 2018], and (3) [Lau 2019]).

### SUMMARY

To address problems with known techniques, a method for generating a motion compensation system is disclosed, comprising obtaining a series of images including movement of at least one object between the series of images, and training a machine learning-based system to produce a trained machine learning-based system for providing one or more motion vectors indicating the movement of the at least one object between the series of images.

In one aspect, the training comprises minimizing a penalized loss function based on a similarity metric. In another aspect, the similarity metric comprises a cross correlation function for correlating plural images of the series of images.

In one aspect, the series of images comprises a moving image and a fixed image, and the training comprises warping the moving image to the fixed image using a differentiable spatial transform.

In one aspect, the machine learning-based system comprises a neural network, and the trained machine learning-based system comprises a trained neural network.

In one aspect, the machine learning-based system comprises a neural network and the trained machine learning-based system comprises a trained neural network, and the trained neural network comprises the neural network trained using unsupervised training.

In one aspect, the machine learning-based system is trained using PET data and/or gated PET data.

Also disclosed is a system for generating a motion compensation system comprising: processing circuitry configured to: obtain a series of images including movement of at least one object between the series of images; and train a machine learning-based system based on the series of images to produce a trained machine learning-based system for providing at least one motion vector indicating a movement of the at least one object between the series of images.

In one aspect, the processing circuitry configured to train comprises processing circuitry configured to minimize a penalized loss function based on a similarity metric. In another aspect, the similarity metric comprises a cross correlation function for correlating plural images of the series of images.

In one aspect, the series of images comprises a moving image and a fixed image, and the processing circuitry configured to train comprises processing circuitry configured to warp the moving image to the fixed image using a differentiable spatial transform.

In one aspect, the machine learning-based system comprises a neural network and the trained machine learning-based system comprises a trained neural network.

In one aspect, the machine learning-based system comprises a neural network and the trained machine learning-based system comprises a trained neural network, and the trained neural network comprises the neural network trained using unsupervised training.

In one aspect, the machine learning-based system is trained using PET data and/or gated PET data.

This method and system can be implemented in a number of technologies but generally utilize processing circuitry for performing the functions described herein.

Note that this summary section does not specify every embodiment and/or incrementally novel aspect of the present disclosure or claimed invention. Instead, this summary only provides a preliminary discussion of different embodiments and corresponding points of novelty. For additional details and/or possible perspectives of the invention and embodiments, the reader is directed to the Detailed Description section and corresponding figures of the present disclosure as further discussed below.

### BRIEF DESCRIPTION OF THE DRAWINGS

FIG. 1 outlines one method for using a trained neural network to produce a deformation field for performing motion compensated image reconstruction.

FIG. 2A shows an input/output diagram for a first configuration where the input into the trained neural network is a source image and reference image, and the output is a deformation field.

FIG. 2B shows a second configuration where the input into the trained neural network is a source image, reference image, and motion tracking signal, and the output is a deformation field.

FIG. 2C shows a third configuration where in the input into the trained neural network (with or without a motion signal) is more than two gates and the output is multiple deformation fields.

FIG. 3 outlines one method for training a neural network to produce a trained neural network for providing at least one motion vector indicating a movement of at least one object between a series of images.

FIG. 4 is a dataflow diagram of a trainable network for performing motion compensation on images that includes a concatenated series of layers for performing convolution, down-sampling, and up-sampling.

FIG. 5A shows a perspective view of a PET scanner, according to an embodiment of the present disclosure.

FIG. 5B shows a schematic view of a PET scanner, according to an embodiment of the present disclosure.

FIG. 6A is a first sample reconstructed gated PET image by a maximum likelihood expectation-maximization (MLEM) technique (50 iteration).

FIGS. 6B-6H are second through eighth sample reconstructed gated PET images by MLEM technique (using 50 iteration each).

FIG. 7A is a first reconstructed gated PET image of the patient data (MLEM 30 iteration).

FIGS. 7B-7G are second through seventh reconstructed gated PET images of the patient data (using MLEM 30 iterations each).

FIG. 8A is a reconstructed image of the simulated data set (MLEM 30 iteration) showing motion compensated reconstruction using a deep neural network for motion estimation.

FIG. 8B is a reconstructed image of the simulated data set (MLEM 30 iteration) showing motion compensated reconstruction using iterative registration for motion estimation.

FIG. 8C is a reconstructed image of the simulated data set (MLEM 30 iteration) showing an ungated reconstruction.

FIG. 8D is a reconstructed image of the simulated data set (MLEM 30 iteration) showing a reference gate.

FIG. 8E is a reconstructed image of the simulated data set (MLEM 30 iteration) showing the ground truth (no motion).

FIG. 9A is a graph showing the bias-variance trade off curve for the left myocardium ROI.

FIG. 9B is a graph showing the bias-variance trade off curve for the right myocardium ROI.

FIG. 10A is a reconstructed image of real patient data (MLEM 30 iteration) showing motion compensated reconstruction using deep learning for motion estimation.

FIG. 10B is a reconstructed image of real patient data (MLEM 30 iteration) showing motion compensated reconstruction using iterative registration for motion estimation.

FIG. 10C is a reconstructed image of real patient data (MLEM 30 iteration) showing an ungated image.

FIG. 10D is a reconstructed image of real patient data (MLEM 30 iteration) showing the reference gate image.

FIG. 11A is a contrast versus noise curve for the lung lesion.

FIG. 11B is a graph (plotted on a logarithmic scale) of registration runtimes of the neural network (deep learning) and iterative registration method for a pair of images.

FIG. 12A is a first reconstructed gated PET image of additional real patient data (MLEM 30 iteration).

FIGS. 12B-12C are second through third reconstructed gated PET images of additional real patient data (using MLEM 30 iteration each).

FIG. 13A is a reconstruction image of additional real patient data (MLEM 30 iteration) showing motion compensated reconstruction using deep learning for motion estimation.

FIG. 13B is a reconstruction image of additional real patient data (MLEM 30 iteration) showing motion compensated reconstruction using iterative registration for motion estimation.

FIG. 13C is a reconstruction image of additional real patient data (MLEM 30 iteration) showing an ungated image.

FIG. 13D is a reconstruction image of additional real patient data (MLEM 30 iteration) showing the reference gate image.

FIG. 14 is a contrast versus noise curve for a lesion at the liver boundary.

### DETAILED DESCRIPTION

An unsupervised non-rigid image registration method and system are described herein that use deep learning and incorporate the estimated deformation field into image reconstruction for motion correction (e.g., for use in PET image reconstruction). A deformation field, sometimes referred to as a motion field, can comprise one or more motion vectors indicating movement of one or more objects.

In one embodiment, a system estimates the motion vectors between two gated images by using a neural network (instead of trying to register the images to each other). The neural network is trained by minimizing an image dissimilarity metric between fixed and warped moving images with a proper regularization. This unsupervised approach does not require ground truth for training the neural network, which makes it convenient to implement. Instead of registering the images to each other, the images are fed into the neural network that is trained for motion vector estimation and the neural network directly outputs the motion vectors. In addition to using other possible inputs, the neural network is trained using gated or ungated PET data. Once motion vectors are obtained, they can become part of the forward model in model-based motion corrected image reconstruction. Such a technique directly produces one motion corrected image from data corresponding to all the gates. Alternatively, if each gate is already reconstructed and one wishes to obtain a single motion corrected image, the reconstructed gates could be transformed to a reference gate using the motion vectors. This produces a single, low-noise, approximately motion-frozen image. While model-based motion correction is theoretically more rigorous, this post-reconstruction allows for motion correction to be applied directly to images, even if the original data is lost. In one embodiment, the neural network uses a differentiable spatial transformer layer to warp the moving image to the fixed image and uses a stacked structure for deformation field refinement.

Estimated deformation fields can be incorporated into an iterative image reconstruction technique to perform motion compensated PET image reconstruction. The described method was validated using simulation and clinical data and implemented an iterative image registration approach for comparison. Motion compensated reconstructions were compared with ungated images.

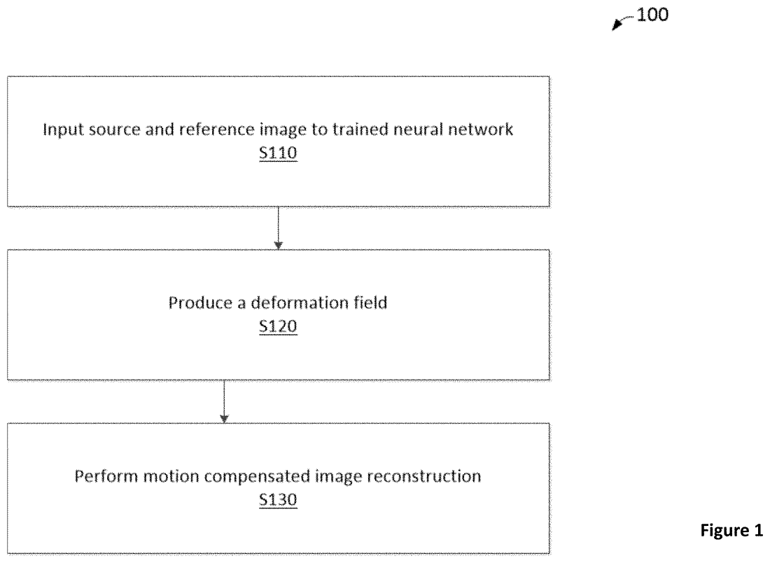

FIG. 1 shows one method 100 for using a trained neural network for motion estimation. The first step S110 can include inputting one or more source and reference images to the trained neural network, such as gated or ungated PET images. The source and reference images can be one or more moving and fixed images. In the next step S120, the trained neural network can estimate and produce one or more motion vectors making up a deformation field. The motion vectors/deformation field can indicate movement of at least one object between the source and reference image inputs from S110. The last step S130 can include performing motion compensated image reconstruction using the deformation field produced from S120 by incorporating it into an iterative image reconstruction technique.

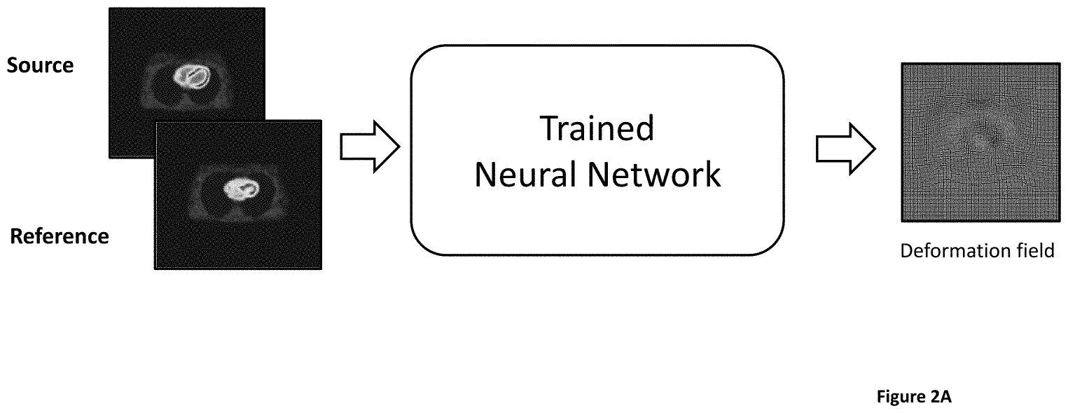

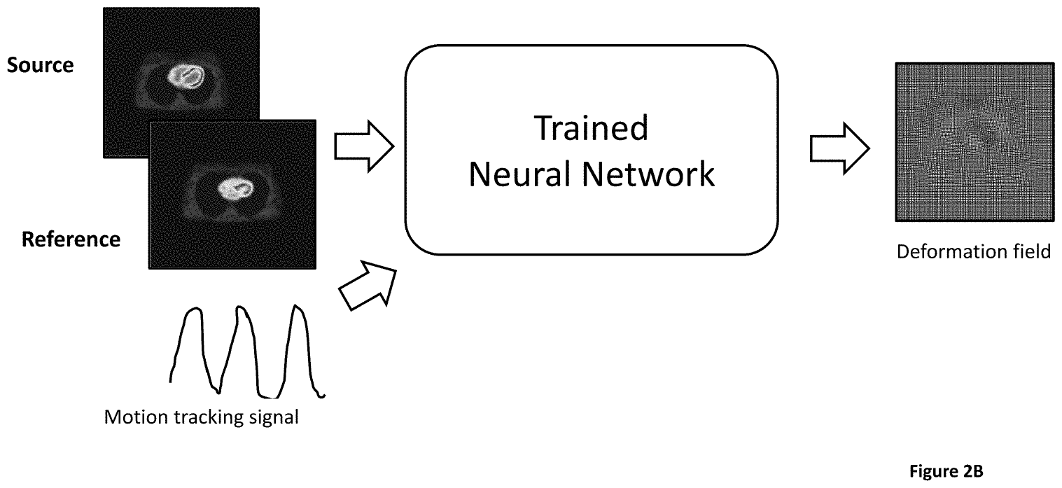

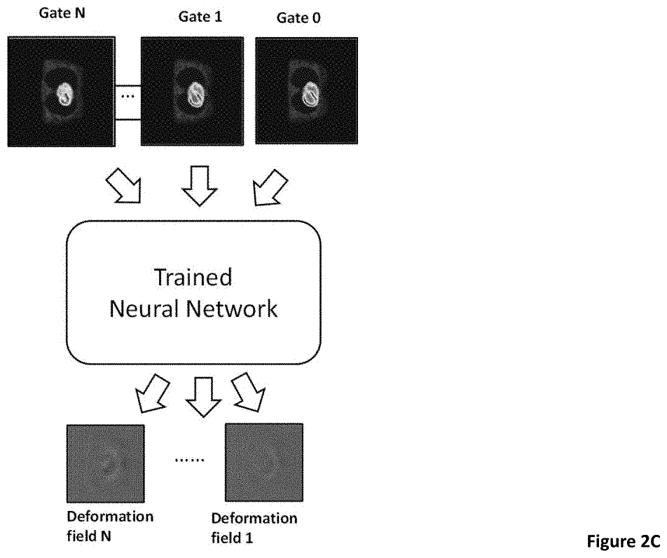

The input source and reference images in step S110 can include various configurations. For example, FIGS. 2A-2C show three possible inputs and outputs for the trained neural network. FIG. 2A shows a first configuration, where a source and reference image are input into the trained neural network and a deformation field is output. Note that non image-based training is also possible. In FIG. 2B, a source, reference, and motion tracking signal are input into the trained neural network and a deformation field is output. Exemplary motion tracking signals include, but are not limited to, signals representing a respiratory cycle, heart rate, and cardiac trace. Furthermore, this technique is not limited to only a pair of images. More than two gate images can be input into the motion estimation neural network (with or without a motion signal) and multiple deformation fields can be output. As shown in FIG. 2C, more than two gates are input into the trained neural network, and multiple deformation fields are output.

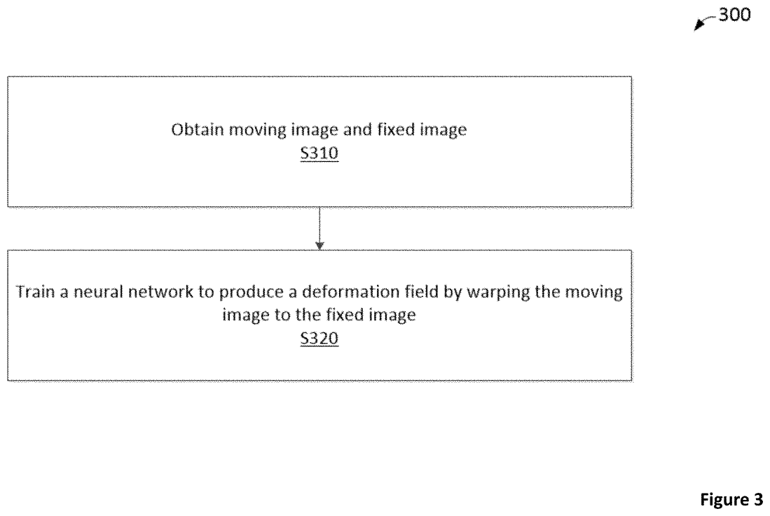

FIG. 3 shows one method 300 for training a neural network to produce a trained neural network (for motion estimation). The first step S310 can include obtaining a series of one or more fixed and moving images including movement of at least one object between the series of images, for example a patient's beating heart. In one embodiment, the series of images used for the training process can be PET data and/or gated PET data. In the next step S320, these images can be used as training data for training the neural network. The training can include warping the moving image to the fixed image by using a differentiable spatial transform. In one aspect, the training can comprise minimizing a penalized loss function based on a similarity metric, said similarity metric comprising a cross correlation function for correlating the images.

Additional details regarding training the neural network in S320, and, upon training completion, utilizing the trained neural network to produce a deformation field in S120 will now be discussed. The goal of this neural network is to predict a deformation field (θ) between a moving image (xₘ) and a fixed image (x_{f}) that minimizes a penalized loss function such as:

$$θ = {arg min}_{θ} - S ( T ( {x}_{m} , θ ) , {x}_{f} ) + λ U ( θ ) , \qquad ( 1 )$$

where S(•,•) is an image similarity metric, the operator T(xₘ, θ) deforms xₘ based on the deformation field θ, U(θ) is a regularization function on θ, and λ is a weighting factor. In this embodiment, cross correlation (CC) (See, e.g., [Balakrishnan 2018]) is used as the similarity metric.

The CC between fixed and warped moving images is defined as:

$$\begin{matrix}C C ( M , {x}_{f} ) = {\sum }_{i ∈ Ω} ( \frac{\begin{matrix}{\sum }_{{p}_{i}} ( {x}_{f} ( {p}_{i} ) - {\overline{x}}_{f} ( i ) ) \\ ( M ( {p}_{i} ) - \overline{M} ( i ) )\end{matrix}}{\sqrt{\begin{matrix}{\sum }_{{p}_{i}} {( {x}_{f} ( {p}_{i} ) - {\overline{x}}_{f} ( i ) )}^{2} \\ {\sum }_{{p}_{i}} {( M ( {p}_{i} ) - \overline{M} ( i ) )}^{2}\end{matrix}}} ) , M \\ = T ( {x}_{m} , θ )\end{matrix} \qquad ( 2 )$$

where pᵢ can iterate over an a×b×c rectangular volume around voxel i, where a, b, and c represent the dimensions of the rectangular volume, x̅_{f}(i) and M̅(i) are the mean values inside the a×b×c rectangular volume around voxel i in the two images, respectively. The dimensions a, b, and c may be different such that the volume is rectangular, or they may be the same thereby creating a cubic volume (which is a special case of a rectangular volume).

In order to obtain a smoothed θ, an L-2 norm regularizer on the gradients of the deformation field is applied. Then the loss function can be written as:

Loss(xₘ, x_{f}, θ)=−CC(T(xₘ, θ),x_{f})+λΣ∥∇θ∥². (3)

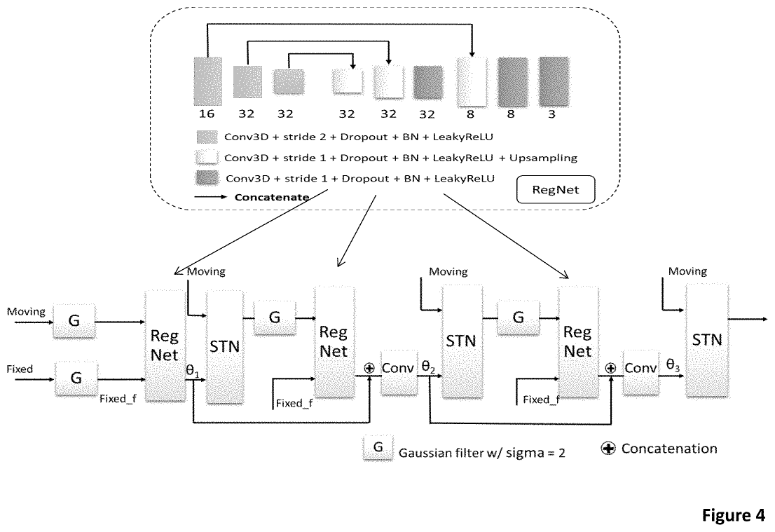

A stacked framework can be employed, which comprises of three subunits. Each subunit can consist of a 9-layer encoder-decoder called “RegNet” and a STN. The RegNet includes of a series of concatenated layers as shown in FIG. 4, including convolution, down-sampling, and up-sampling layers. In one embodiment, the kernel size (i.e., the values for a, b, and c) is 3×3×3 in all convolutional layers. Batch Normalization (BN) can then be used after each convolutional layer. (See, e.g., [Ioffe and Szegedy 2015]: (Ioffe S and Szegedy C 2015 Batch normalization: Accelerating deep network training by reducing internal covariate shift arXiv preprint arXiv:1502.03167)), Dropout (See, e.g., [Srivastava 2014]: (Srivastava N, Hinton G, Krizhevsky A, Sutskever I and Salakhutdinov R 2014 Dropout: a simple way to prevent neural networks from overfitting J Mach Learn Res 15 1929-58)) and Leaky Rectified Linear Unit activation (Leaky ReLU) (See, e.g., [Maas 2013]: (Maas A L, Hannun A Y and Ng A Y 2013 Rectifier nonlinearities improve neural network acoustic models Proceedings of Machine Learning Research 30 3)). Unsupervised learning is realized by using the differentiable STN (See, e.g., [Jaderberg 2015]) to warp the moving image and by comparing the warped image to the fixed image. The warped image based on the intermediate estimate is then fed into the next subunit for refinement. The estimated deformation field of each subunit is combined with the result from the previous subunit through a convolution layer. A Gaussian filter is applied to the input gated PET images to reduce noise.

Let y^{k}, k ∈ {1,2, . . . K}, be the measured PET data in the kth gate and y̅^{k} be the expectation of the measurement. The log-likelihood of all gated PET data is:

L(y¹, . . . , y^{K}|x)=Σₖ{yᵢ^{k} ln(y̅ᵢ^{k})−y̅ᵢ^{k}}. (4)

The expectation y̅^{k} is related to the reference gate PET image x through

y̅^{k}=w^{k}·N·A^{k}·P·T(x,θ^{k})+s^{k}+r^{k},

where the (i, j)th element of P ∈ [symbol] ^{M×N}, p_{i,j}, denotes the probability of detecting an emission from pixel j , j ∈ {1, . . . , N}, at detector pair i , i ∈ {1, . . . , M}, N ∈ [symbol] ^{M×M} and A^{k} ∈ [symbol] ^{M×M} are diagonal matrices containing the normalization factors and attenuation factors, respectively, for the kth gate, s^{k} ∈ [symbol] ^{M×1} denotes the expectation of scattered events and r^{k} ∈ [symbol] ^{M×1} denotes the expectation of random events for the kth gate, and θ^{k} is the estimated deformation field from the reference gate to the kth gate. The weighting factor w^{k} accounts for the duration of gate k with Σₖ w^{k}=1.

The maximum likelihood expectation maximization (ML-EM) iteration is (See, e.g., [Li 2006]: (Li T, Thorndyke B, Schreibmann E, Yang Y and Xing L 2006 Model-based image reconstruction for four-dimensional PET Med Phys 33 1288-98)):

$${x}^{n + 1} = \frac{{x}^{n}}{{\sum }_{k} {w}^{k} \cdot {T}^{*} ( {u}^{k} , {θ}^{k} )} \cdot {\sum }_{k} {w}^{k} \cdot {T}^{*} ( {P}^{T} \frac{{y}^{k}}{{w}^{k} \cdot P \cdot T ( x , {θ}^{k} ) + \frac{{s}^{k} + {r}^{k}}{N \cdot {A}^{k}}} , {θ}^{k} ) , \qquad ( 5 )$$

where u^{k} denotes the sensitivity image with uⱼ^{k}=Σᵢ[N·A^{k}·P]_{i,j}, and the multiplications and divisions between the vectors are performed element-wise. The update procedure begins with deforming current image from the reference gate to other gates. After the deformation, a standard forward projection and back projection are performed to get the error image of that gate. All error images are deformed back to the reference gate and summed together. Finally, the current image is updated using the summation of deformed error images.

The loss function allows for the unsupervised training of the neural network. When it is fully trained, the trained neural network directly produces the deformation field from the pair of fixed and moving images. One can use multiple neural network structures to attempt to minimize the loss function and the parameters of those networks will form the trained neural network to be used with a new pair of images.

The present disclosure also presents a system for generating a motion compensation system comprising: processing circuitry configured to: obtain a series of images including movement of at least one object between the series of images; and train a machine learning-based system based on the series of images to produce a trained machine learning-based system for providing at least one motion vector indicating a movement of the at least one object between the series of images.

In one exemplary aspect, the processing circuitry minimizes a penalized loss function based on a similarity metric. The similarity metric can include a cross correlation function for correlating plural images of the series of images.

In one exemplary aspect, the series of images include a moving image and a fixed image, and the processing circuitry is configured to warp the moving image to the fixed image using a differentiable spatial transform.

In one exemplary aspect, the machine learning-based system is a neural network and the trained machine learning-based system is trained neural network. In a further aspect, the machine learning-based system is a neural network, and the trained machine learning-based system is a trained neural network trained using unsupervised training.

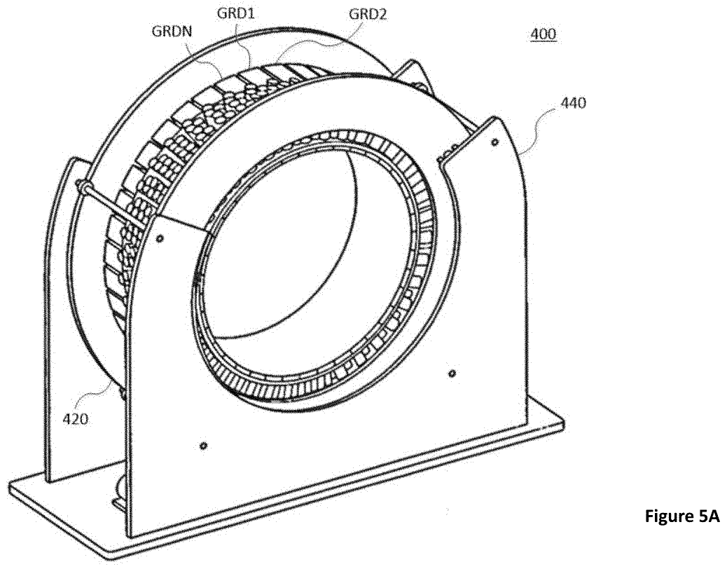

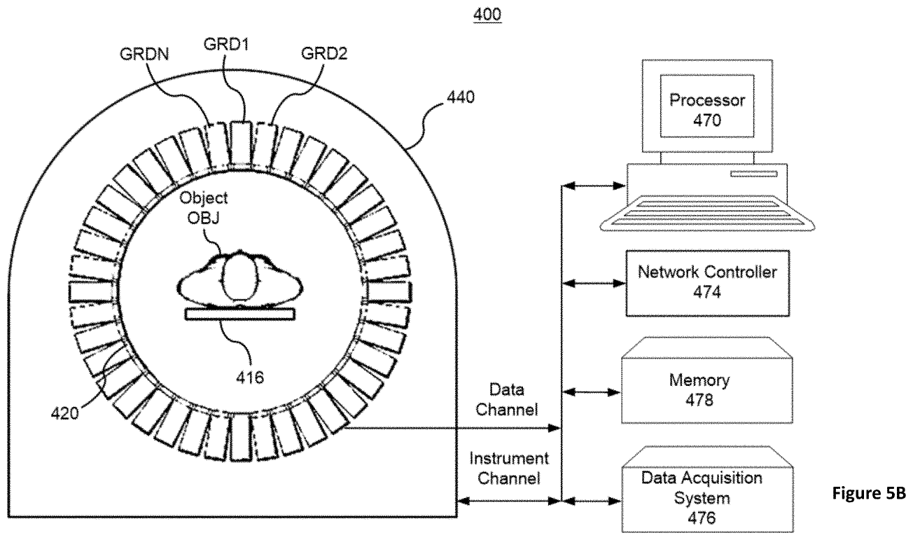

It can be appreciated that the above mentioned techniques can be incorporated into various systems, such as a computed tomography (CT) system, an X-ray system, a PET-CT system, etc. In one embodiment, the above mentioned techniques can be incorporated into a PET system and use gated PET data. FIGS. 5A and 5B show a non-limiting example of a PET scanner 400 that can implement the methods 100 and/or 300. The PET scanner 400 includes a number of gamma-ray detectors (GRDs) (e.g., GRD1, GRD2, through GRDN) that are each configured as rectangular detector modules. According to one implementation, the detector ring includes 40 GRDs. In another implementation, there are 48 GRDs, and the higher number of GRDs is used to create a larger bore size for the PET scanner 400.

Each GRD can include a two-dimensional array of individual detector crystals, which absorb gamma radiation and emit scintillation photons. The scintillation photons can be detected by a two-dimensional array of photomultiplier tubes (PMTs) that are also arranged in the GRD. A light guide can be disposed between the array of detector crystals and the PMTs.

Alternatively, the scintillation photons can be detected by an array a silicon photomultipliers (SiPMs), and each individual detector crystals can have a respective SiPM.

Each photodetector (e.g., PMT or SiPM) can produce an analog signal that indicates when scintillation events occur, and an energy of the gamma ray producing the detection event. Moreover, the photons emitted from one detector crystal can be detected by more than one photodetector, and, based on the analog signal produced at each photodetector, the detector crystal corresponding to the detection event can be determined using Anger logic and crystal decoding, for example.

FIG. 5B shows a schematic view of a PET scanner system having gamma-ray (gamma-ray) photon counting detectors (GRDs) arranged to detect gamma-rays emitted from an object OBJ. The GRDs can measure the timing, position, and energy corresponding to each gamma-ray detection. In one implementation, the gamma-ray detectors are arranged in a ring, as shown in FIGS. 5A and 5B. The detector crystals can be scintillator crystals, which have individual scintillator elements arranged in a two-dimensional array and the scintillator elements can be any known scintillating material. The PMTs can be arranged such that light from each scintillator element is detected by multiple PMTs to enable Anger arithmetic and crystal decoding of scintillation event.

FIG. 5B shows an example of the arrangement of the PET scanner 400, in which the object OBJ to be imaged rests on a table 416 and the GRD modules GRD1 through GRDN are arranged circumferentially around the object OBJ and the table 416. The GRDs can be fixedly connected to a circular component 420 that is fixedly connected to the gantry 440. The gantry 440 houses many parts of the PET imager. The gantry 440 of the PET imager also includes an open aperture through which the object OBJ and the table 416 can pass, and gamma-rays emitted in opposite directions from the object OBJ due to an annihilation event can be detected by the GRDs and timing and energy information can be used to determine coincidences for gamma-ray pairs.

In FIG. 5B, circuitry and hardware is also shown for acquiring, storing, processing, and distributing gamma-ray detection data. The circuitry and hardware include: a processor 470, a network controller 474, a memory 478, and a data acquisition system (DAS) 476. The PET imager also includes a data channel that routes detection measurement results from the GRDs to the DAS 476, the processor 470, the memory 478, and the network controller 474. The DAS 476 can control the acquisition, digitization, and routing of the detection data from the detectors. In one implementation, the DAS 476 controls the movement of the bed 416. The processor 470 performs functions including reconstructing images from the detection data, pre-reconstruction processing of the detection data, and post-reconstruction processing of the image data, as discussed herein.

In one embodiment, the processor 470 can be configured to perform various steps of methods 100 and/or 300 described herein and variations thereof. The processor 470 can include a CPU that can be implemented as discrete logic gates, as an Application Specific Integrated Circuit (ASIC), a Field Programmable Gate Array (FPGA) or other Complex Programmable Logic Device (CPLD). An FPGA or CPLD implementation may be coded in VHDL, Verilog, or any other hardware description language and the code may be stored in an electronic memory directly within the FPGA or CPLD, or as a separate electronic memory. Further, the memory may be non-volatile, such as ROM, EPROM, EEPROM or FLASH memory. The memory can also be volatile, such as static or dynamic RAM, and a processor, such as a microcontroller or microprocessor, may be provided to manage the electronic memory as well as the interaction between the FPGA or CPLD and the memory.

Alternatively, the CPU in the processor 470 can execute a computer program including a set of computer-readable instructions that perform various steps of method 100 and/or method 300, the program being stored in any of the above-described non-transitory electronic memories and/or a hard disk drive, CD, DVD, FLASH drive or any other known storage media. Further, the computer-readable instructions may be provided as a utility application, background daemon, or component of an operating system, or combination thereof, executing in conjunction with a processor, such as a Xenon processor from Intel of America or an Opteron processor from AMD of America and an operating system, such as Microsoft VISTA, UNIX, Solaris, LINUX, Apple, MAC-OS and other operating systems known to those skilled in the art. Further, CPU can be implemented as multiple processors cooperatively working in parallel to perform the instructions.

The memory 478 can be a hard disk drive, CD-ROM drive, DVD drive, FLASH drive, RAM, ROM or any other electronic storage known in the art.

The network controller 474, such as an Intel Ethernet PRO network interface card from Intel Corporation of America, can interface between the various parts of the PET imager. Additionally, the network controller 474 can also interface with an external network. As can be appreciated, the external network can be a public network, such as the Internet, or a private network such as an LAN or WAN network, or any combination thereof and can also include PSTN or ISDN sub-networks. The external network can also be wired, such as an Ethernet network, or can be wireless such as a cellular network including EDGE, 3G and 4G wireless cellular systems. The wireless network can also be WiFi, Bluetooth, or any other wireless form of communication that is known.

The method and system described herein can be implemented in a number of technologies but generally relate to imaging devices and/or processing circuitry for performing the processes described herein. In an embodiment in which neural networks are used, the processing circuitry used to train the neural network need not be the same as the processing circuitry used to implement the trained neural network that performs the calibration described herein. For example, an FPGA may be used to produce a trained neural network (e.g. as defined by its interconnections and weights), and the processor 470 and memory 478 can be used to implement the trained neural network. Moreover, the training and use of a trained neural network may use a serial implementation or a parallel implementation for increased performance (e.g., by implementing the trained neural network on a parallel processor architecture such as a graphics processor architecture).

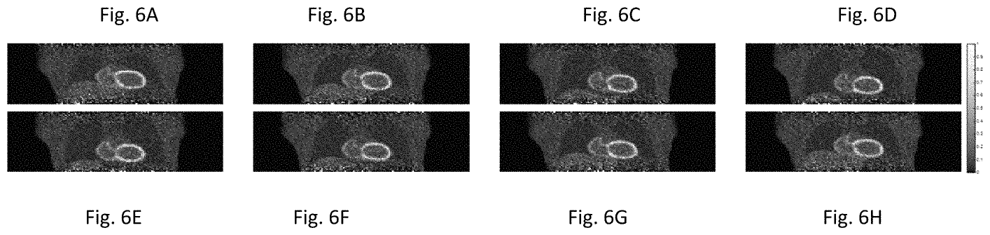

The above mentioned techniques were performed and evaluated. Twenty-two XCAT phantoms (See, e.g., [Segars 2010]: (Segars W, Sturgeon G, Mendonca S, Grimes J and Tsui B M 2010 4D XCAT phantom for multimodality imaging research Med Phys 37 4902-15)) with various organ sizes and genders (11 Male and 11 Female) were generated (10 for training, 1 for validation and 11 for testing). Each modeled a respiratory motion amplitude between 2 and 4 cm with a period of 5 sec. The respiratory cycle was divided into 8 gates, each with a matched attenuation map. Activity parameters included a 5% variation to simulate the population difference. A Canon PET/CT scanner geometry was simulated using the SimSET Monte-Carlo toolkit (See, e.g., [Harrison 1993]: (Harrison R, Haynor D, Gillispie S, Vannoy S, Kaplan M and Lewellen T 1993 A public-domain simulation system for emission tomography-photon tracking through heterogeneous attenuation using importance sampling J Nucl Med 34 60)). The scanner consisted of 40 detector blocks arranged in a ring of diameter 90.9 cm. Each block contained 16×48 lutetium-based scintillation crystals. The individual crystal size is 4×4×12 mm³. A 200 MBq ¹⁸F-FDG injection and a 20 min PET scan starting from 1 hour post-injection was simulated (See, e.g., [Zhang 2014]: (Zhang X, Zhou J, Wang G, Poon J, Cherry S, Badawi R and Qi J 2014 Feasibility study of micro-dose total-body dynamic PET imaging using the EXPLORER scanner J Nucl Med 55 269)). Only true coincidences were used for reconstruction, since perfect scatter and random correction was assumed. For motion estimation, gated PET images were first reconstructed using the ML-EM technique (50 iterations) with normalization and attenuation corrections. The image matrix size was 128×128×48 with a voxel size of 4.08×4.08×4.08 mm³. FIGS. 6A-6H each show sample images of reconstructed MLEM images (50 iterations) at unique gates. The end-inspiration phase was chosen as the reference gate. In total 70 (7 moving gates for each of the 10 phantoms) 3D training pairs were generated, each containing 48 axial slices.

The network was implemented using Keras 2.2.4 with a Tensorflow 1.5.0 backend. The adaptive moment estimation (ADAM) optimizer with a learning rate of 0.005 and batch size of 1 was used. Moving-reference image pairs were fed into the network for training and the network was trained with 3000 epochs. After the training, deformation fields (θ) between any pair of images can be estimated by feeding the moving and fixed images into the network.

For comparison, an iterative image registration with regularization was also implemented to encourage the deformation to be invertible (See, e.g., [Chun and Fessler 2009b]: (Chun S Y and Fessler J A 2009b A simple regularizer for B-spline nonrigid image registration that encourages local invertibility IEEE J Sel Top Signal Process 3 159-69)) using a publicly available B-spline toolbox (Part of Michigan Image Reconstruction Toolbox (MIRT) from http://web.eecs.umich.edu/˜fessler/code/index). The default weighted-least-squares similarity measure was used. The number of iterations was chosen to be 200 based on the visual assessment of the deformation field. Motion compensated reconstructions were performed by running the ML-EM technique in (5) for 50 iterations using deformation fields estimated either from the neural network or the iterative registration software.

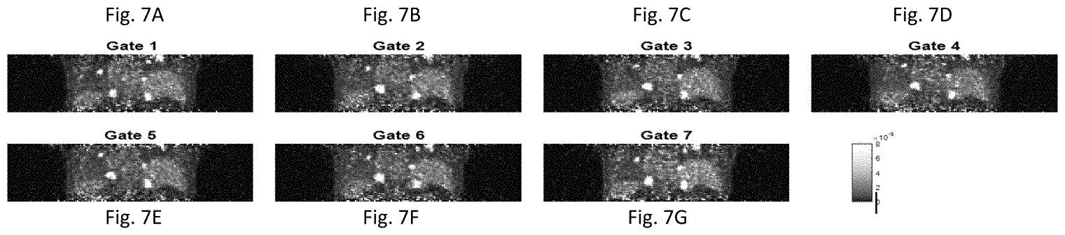

A patient dataset was obtained from the Canon whole-body TOF PET/CT scanner using an ¹⁸F-FDG injection). Two 50% overlapping bed positions were acquired. The list-mode data were divided into 7 respiratory gates based on an externally measured respiratory signal (See, e.g., [Heinz 2015]: (Heinz C, Reiner M, Belka C, Walter F and Söhn M 2015 Technical evaluation of different respiratory monitoring systems used for 4D CT acquisition under free breathing J Appl Clin Med Phys 16 334-49)). Events in irregular breathing cycles were rejected (bed 1: 9.9%, bed 2: 22.0%). Gated PET data were first reconstructed with ML-EM (30 iterations) to estimate the deformation fields, which were then fed into the motion compensated reconstruction for 50 iterations. The normalization factors were computed based on a uniform cylinder scan. The attenuation factors were obtained from a helical CT scan. The attenuation map was not gated and was used for all gates. Randoms were estimated using the delayed window method. Scatters were estimated using the single-scatter simulation. FIGS. 7A-7G show the reconstructed gated PET images of gates 1-7, respectively. Due to the difference between real data and simulation, the network was fine-tuned using the first-bed data with 500 epochs and then applied to the second-bed data for evaluation.

For the simulation study, the reference gate with 8× counts (same as the ungated data) was reconstructed and used as the ground truth for quantitative evaluation. The normalized root mean square error (NRMS) between different reconstructions and the ground truth were calculated:

$$NR MS = \frac{1}{{‖ \overline{x} ‖}_{2}} \sqrt{\frac{1}{N} {\sum }_{i = 1}^{N} {\vert {x}_{i} - {\overline{x}}_{i} \vert}^{2}} \qquad ( 6 )$$

where x denotes the ungated image or a motion compensated reconstructed image and x̅ denotes the ground truth. N denotes the number of voxels in the image.

For region of interest (ROI) quantification, a calculation was performed on the bias compared with the original phantom in the left and right myocardium regions and the standard deviation (STD) in the lung background. The percentage difference relative to the mean was used for both bias and STD.

For the real data study, a lesion ROI was drawn on the reference gate image for quantification. Due to the lack of a ground truth, a contrast-noise curve was used for the evaluation. The contrast was calculated by taking the ratio between the mean of the lesion ROI and the mean of a background ROI in the liver. The background noise was calculated as the variance of the liver ROI over its mean.

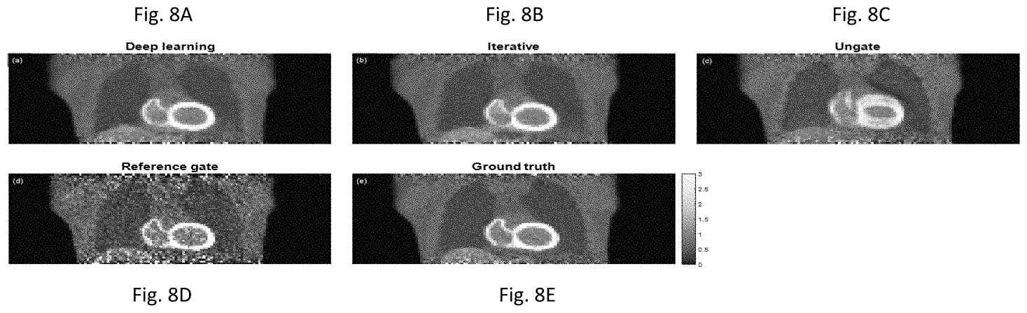

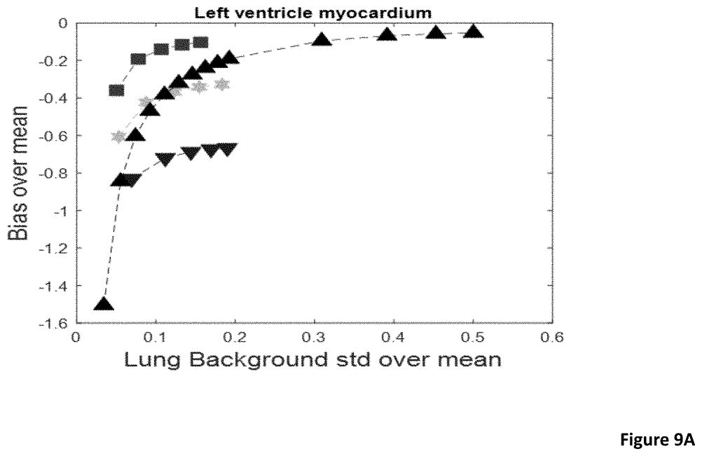

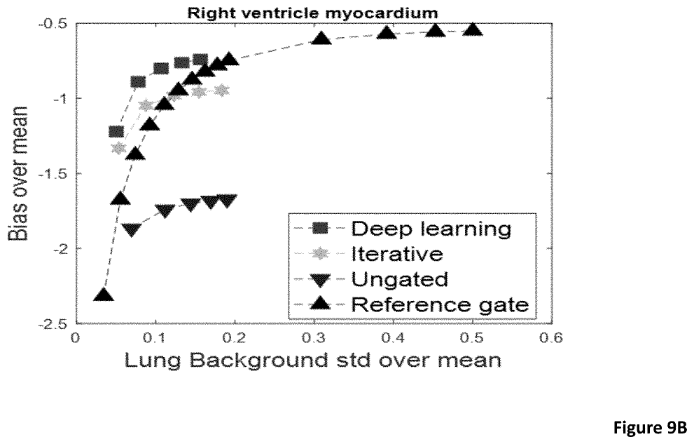

FIGS. 8A-8E show a coronal slice of the reconstructed images of a test phantom with and without (ungated) motion correction. FIG. 8A shows a motion compensated reconstruction image of the simulated data set (MLEM 30 iteration) using a deep neural network for motion estimation, FIG. 8B shows a motion compensated reconstruction image of the simulated data set (MLEM 30 iteration) using iterative registration for motion estimation, FIG. 8C shows an ungated reconstruction image, FIG. 8D shows a reference gate image, and FIG. 8E shows a ground truth (no motion) image. The ungated image in FIG. 8C looked blurry in the cardiac region and near the liver-lung boundary, while the motion compensated method using either the deep neural network or the iterative registration for deformation field estimation can generate images with sharp boundaries and reveal more details in the heart region. The bias-variance curve of the left myocardium ROIs are plotted and shown in FIG. 9A, and the bias-variance curve of the right myocardium ROIs are plotted and shown in FIG. 9B. All the methods were plotted by 10-MLEM-iteration intervals except the reference gate which also included 1 to 9 iterations for better comparison. STD increased with increasing iterations. For both ROIs, the reference gate image exhibited much higher noise than either the ungated image or the motion corrected images. Both motion corrected reconstructions reduced the bias compared with the ungated image without increasing the noise level and the deep learning approach outperformed the iterative registration method with less bias.

For all 11 test phantoms, the NRMS of reconstructed images at the 30th MLEM iteration was computed. The results are shown in Table 1 below. The mean and standard deviation of the NRMS values were 24.3±1.7% for the deep learning based motion correction, 31.1±1.4% for the iterative registration based motion correction, 41.9±2.0% for ungated reconstruction, and 42.6±4.0% for the reference gate reconstruction. Clearly the proposed deep learning based method achieved the best performance.

TABLE 1
NRMS of reconstructed images for different
methods at the 30th MLEM iteration.

| Test | Deep | | | Reference |
|---|---|---|---|---|
| Phantom # | learning | Iterative | Ungated | gate |
| #1 | 23.9% | 34.3% | 44.0% | 35.1% |
| #2 | 25.2% | 28.1% | 40.2% | 44.2% |
| #3 | 23.0% | 30.7% | 40.9% | 40.9% |
| #4 | 22.2% | 31.2% | 43.7% | 37.4% |
| #5 | 24.3% | 30.8% | 45.3% | 43.5% |
| #6 | 22.7% | 30.5% | 39.2% | 41.7% |
| #7 | 22.8% | 31.3% | 42.1% | 41.7% |
| #8 | 25.4% | 31.9% | 41.0% | 48.8% |
| #9 | 28.0% | 31.4% | 43.6% | 49.1% |
| #10 | 26.3% | 30.9% | 38.9% | 44.6% |
| #11 | 23.0% | 30.7% | 41.9% | 40.9% |
| Mean | 24.3% | 31.1% | 41.9% | 42.6% |
| STD | 1.7% | 1.4% | 2.0% | 4.0% |

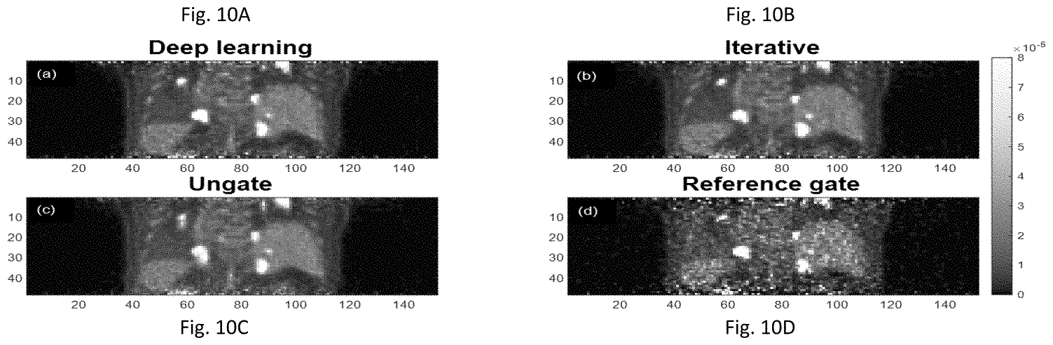

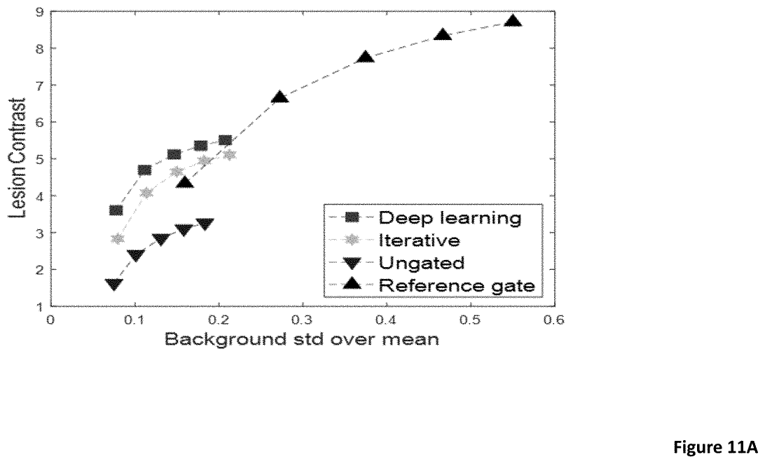

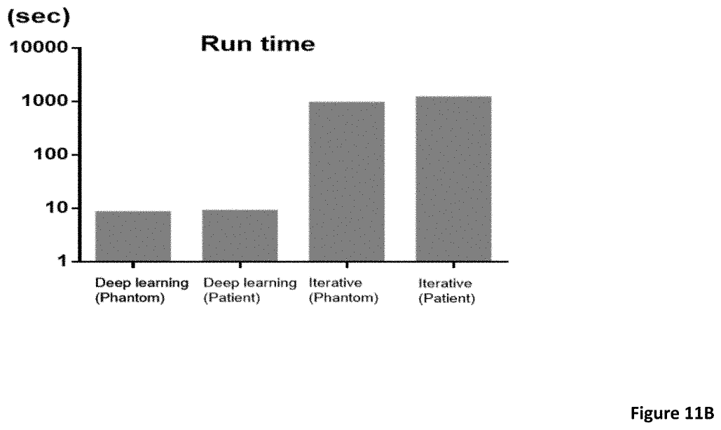

FIGS. 10A-10D show a coronal slice of the reconstructed motion corrected and ungated images in comparison to the reconstructed image of the reference gate. FIG. 10A shows a deep learning motion corrected image, FIG. 10B shows an iterative motion corrected image, FIG. 10C shows an ungated image, and FIG. 10D shows a reference gate image. Both motion compensated images provided higher lesion contrast and sharper liver boundaries than the ungated image and had lower noise than the reference gate image. For quantitative comparison, the contrast-noise curves for a lung lesion were plotted and are shown in FIG. 11A. The contrast of the proposed method based on the deep neural network was higher than that of the ungated image and iterative registration method at any matched background STD level.

Deep learning is a very fast registration approach after a one-time training process, which took a few days on an Nvidia GeForce GTX 1080 ti GPU. Depending on the image size, the iterative registration time of a single pair of images took about 15 to 20 mins, while for the deep learning method it only took 8 secs to register a test pair of images. The runtimes of the neural network and iterative registration are compared in FIG. 11B, with the neural network being about 100 times faster than the iterative method. This fast registration of PET images significantly speeds up image analysis and processing pipelines, which can facilitate novel directions in respiratory and cardiac motion correction and body movement during long time dynamic PET scans.

Thus, the feasibility of incorporating 4D deformation fields from deep learning into motion compensated PET image reconstruction has been demonstrated. In addition to the computational speed advantage, higher registration accuracy is achieved for the deep learning method compared with the iterative registration method. This could be attributed to the training of the deep neural network using an ensemble of image pairs, which improved the robustness of the image registration. Unsupervised spatial registration methods advantageously do not need ground truth. Compared with supervised learning which uses ground truth deformation fields from iterative registration, unsupervised approaches have the potential to achieve better registration accuracy. In addition, to account for both potential large displacements and fine deformations between images, a stacked architecture estimates coarse-to-fine deformation fields, where the front layer estimates a coarse deformation field with large displacements, and the back layers provide fine deformation field. Although the network was trained based on respiratory motions, other kinds of motion similarly may be addressed. To demonstrate this, a moderate bulk body motion (1-3 voxels) was superimposed on the simulated respiratory motion and fed the images into the network without any retraining. The RMSE between the predicted warped image and the fixed image increased by 1.3% for 1-voxel shift and 13.7% for 3-voxel shift compared to the results without the bulk body motion. Deformation fields having a larger deviation from the training data can require either retraining or fine tuning as we did for the patient data. This problem could also be solved by increasing the training data size to better match the real data.

Motion-independent correction factors for attenuation, random events, and scattered events were used. The expectation of the scattered and random events were estimated based on ungated emission data. The random events estimation is the least sensitive to motion, because it was determined by the singles rates of the detectors. Scatter distribution is also less affected by respiratory motion than true coincidences because it has a much smoother distribution than the true events. The correction factor that is the most sensitive to motion is the attenuation factor. Approaches to compensate for motion in attenuation factors have been proposed and can be combined with the deep learning based motion estimation method proposed here. (See, e.g., (1) [Alessio 2007]: (Alessio A M, Kohlmyer S, Branch K, Chen G, Caldwell J and Kinahan P 2007 Cine CT for attenuation correction in cardiac PET/CT J Nucl Med 48 794-801), and (2) [Lu 2018]: (Lu Y, Fontaine K, Mulnix T, Onofrey J A, Ren S, Panin V, Jones J, Casey M E, Barnett R and Kench P 2018 Respiratory motion compensation for PET/CT with motion information derived from matched attenuation-corrected gated PET data J Nucl Med 59 1480-6)).

A deep learning architecture which can estimate probabilistic diffeomorphic deformations that is differentiable and invertible, and thus can preserve topology (See, e.g., [Dalca 2018]: (Dalca A V, Balakrishnan G, Guttag J and Sabuncu M R 2018 Unsupervised learning for fast probabilistic diffeomorphic registration International Conference on Medical Image Computing and Computer-Assisted Intervention 729-38)) can also be incorporated in the motion compensated image reconstruction framework.

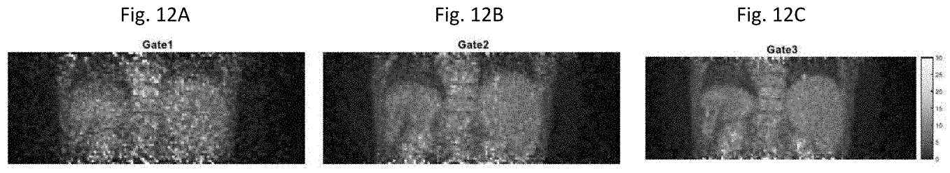

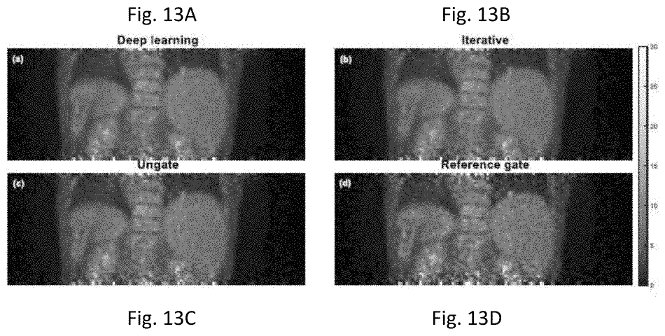

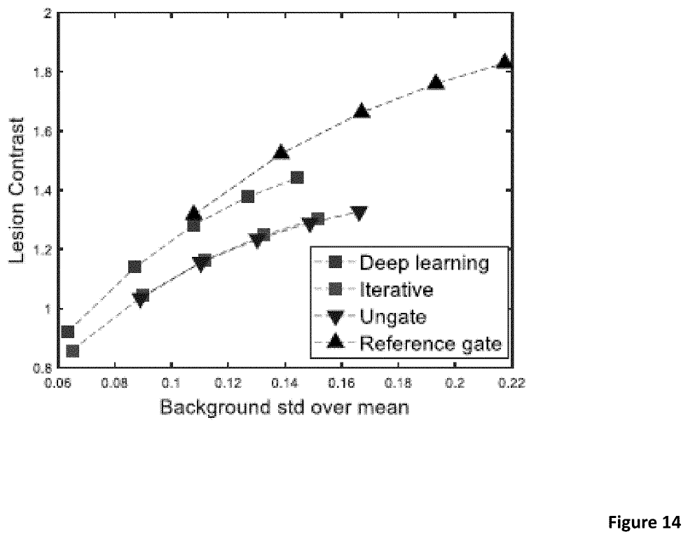

Furthermore, a system according to one embodiment has been validated using one patient with 50% overlapped bed positions. The fine-tuned model might be overfitted to the motion characteristics and tracer distribution specific to this patient. To address this concern, the fine-tuned model was also deployed on another patient scan with three respiratory gated phases for deformation fields estimation. FIGS. 12A-12C shows a first respiratory gated image, second respiratory gated image, and third respiratory gated image, respectively. This dataset has a variable count distribution across the three gates with 11% in gate 1, 31% in gate 2, and 58% in gate 3. The image reconstruction parameters were the same as those given above. Motion compensated reconstructions were performed using deformation fields estimated either from the deep learning or the iterative registration. FIG. 13A shows the reconstructed image using the deep learning approach, FIG. 13B shows the reconstructed image using the iterative approach, FIG. 13C shows the reconstructed ungated image, and FIG. 13D shows the reconstructed reference gate image. Higher lesion contrast and sharper liver boundary were observed for deep learning based method. The iterative registration however failed to capture the lesion motion near the liver boundary since the motion amplitude for this patient was relatively small (1˜2 voxels). The contrast-noise curve for the deep learning based registration was also higher than the iterative based registration and unaged reconstruction as shown in FIG. 14. Since reference gate contains over 50% of the counts, the benefit from motion compensation is not significant.

Note that the deformation fields are estimated from the gated PET images before the motion compensated image reconstruction. In another embodiment, the deep learning method is incorporated in a joint estimation framework with guaranteed convergence. This allows estimation of the image and deformation fields during image reconstruction.

Alternative embodiments also are possible and include, but are not limited to, the following variations:

Similarity metric selection: Different embodiments use different similarity metrics to measure the similarity between the fixed image and the transformed moving image. These include cross correlation, root mean square error, mutual information between image histograms, weighted sums of intensity differences etc.

Regularizer selection: Different embodiments use different regularizing functions to regularize the deformation field estimate. These include L1 and L2 norms of the deformation field gradient, L1 and L2 norms of the deformation field itself, and functions of the Jacobian of the transformation.

Network architecture selection: Different embodiments use different network structures that learn to produce a deformation field from a pair of images. These include not only the disclosed RegNet+STN combination structure, but also linear or U-Net structures or different combinations of basic neural network elements such as convolution operations, activation functions, max pooling and batch normalization.

The disclosed method and system provide enhanced speed, robustness, and simplicity with motion vectors between two gates being produced. The disclosed techniques can lead to a significant reduction in computational cost as compared to commonly used image registration techniques that are computationally very intensive in order to produce realistic motion vectors. Once the neural network is trained, it will rapidly produce motion vectors. This approach will also greatly increase flexibility as one can change the reference gate and quickly obtain the motion vectors instead of running a full new set of registration techniques. This approach also allows for joint motion vector and activity estimation inside a neural network.

As discussed above, the method and system described herein can be implemented in a number of technologies but generally relate to imaging device and/or processing circuitry for performing the motion compensation described herein. In one embodiment, the processing circuitry is implemented as one of or as a combination of: an application specific integrated circuit (ASIC), a field programmable gate array (FPGA), a generic array of logic (GAL), a programmable array of logic (PAL), circuitry for allowing one-time programmability of logic gates (e.g., using fuses) or reprogrammable logic gates. Furthermore, the processing circuitry can include computer processor circuitry having embedded and/or external non-volatile computer readable memory (e.g., RAM, SRAM, FRAM, PROM, EPROM, and/or EEPROM) that stores computer instructions (binary executable instructions and/or interpreted computer instructions) for controlling the computer processor to perform the processes described herein. The computer processor circuitry may implement a single processor or multiprocessors, each supporting a single thread or multiple threads and each having a single core or multiple cores. To reiterate, in an embodiment in which neural networks are used, the processing circuitry used to train the artificial neural network need not be the same as the processing circuitry used to implement the trained artificial neural network that performs the motion compensation described herein. For example, processor circuitry and memory may be used to produce a trained artificial neural network (e.g., as defined by its interconnections and weights), and an FPGA may be used to implement the trained artificial neural network. Moreover, the training and use of a trained artificial neural network may use a serial implementation or a parallel implementation for increased performance (e.g., by implementing the trained neural network on a parallel processor architecture such as a graphics processor architecture).

In the preceding description, specific details have been set forth. It should be understood, however, that techniques herein may be practiced in other embodiments that depart from these specific details, and that such details are for purposes of explanation and not limitation. Embodiments disclosed herein have been described with reference to the accompanying drawings. Similarly, for purposes of explanation, specific numbers, materials, and configurations have been set forth in order to provide a thorough understanding. Nevertheless, embodiments may be practiced without such specific details. Components having substantially the same functional constructions are denoted by like reference characters, and thus any redundant descriptions may be omitted.

Various techniques have been described as multiple discrete operations to assist in understanding the various embodiments. The order of description should not be construed as to imply that these operations are necessarily order dependent. Indeed, these operations need not be performed in the order of presentation. Operations described may be performed in a different order than the described embodiment. Various additional operations may be performed and/or described operations may be omitted in additional embodiments.

Those skilled in the art will also understand that there can be many variations made to the operations of the techniques explained above while still achieving the same objectives of the invention. Such variations are intended to be covered by the scope of this disclosure. As such, the foregoing descriptions of embodiments of the invention are not intended to be limiting. Rather, any limitations to embodiments of the invention are presented in the following claims.

What is claimed is:

1. A method of generating a motion compensation system comprising:
obtaining a series of images including movement of at least one object between the series of images; and
training a machine learning-based system based on the series of images to produce a trained machine learning-based system for providing at least one motion vector indicating a movement of the at least one object between the series of images.

2. The method as claimed in claim 1, wherein the training comprises minimizing a penalized loss function based on a similarity metric.

3. The method as claimed in claim 2, wherein the similarity metric comprises a cross correlation function for correlating plural images of the series of images.

4. The method as claimed in claim 1, wherein the series of images comprises a moving image and a fixed image, and
wherein the training comprises warping the moving image to the fixed image using a differentiable spatial transform.

5. The method as claimed in claim 1, wherein the machine learning-based system comprises a neural network and the trained machine learning-based system comprises a trained neural network.

6. The method as claimed in claim 1, wherein the machine learning-based system comprises a neural network and the trained machine learning-based system comprises a trained neural network, and
wherein the trained neural network comprises the neural network trained using unsupervised training.

7. The method as claimed in any claim 1, wherein the machine learning-based system is trained using PET data.

8. The method as claimed in claim 1, where in the machine learning-based system is trained using gated PET data.

9. A trained machine learning-based system produced according to the method of claim 1.

10. A system for generating a motion compensation system comprising:
processing circuitry configured to:
obtain a series of images including movement of at least one object between the series of images; and
train a machine learning-based system based on the series of images to produce a trained machine learning-based system for providing at least one motion vector indicating a movement of the at least one object between the series of images.

11. The system as claimed in claim 10, wherein the processing circuitry configured to train comprises processing circuitry configured to minimize a penalized loss function based on a similarity metric.

12. The system as claimed in claim 11, wherein the similarity metric comprises a cross correlation function for correlating plural images of the series of images.

13. The system as claimed in claim 10, wherein the series of images comprises a moving image and a fixed image, and
wherein the processing circuitry configured to train comprises processing circuitry configured to warp the moving image to the fixed image using a differentiable spatial transform.

14. The system as claim in claim 10, wherein the machine learning-based system comprises a neural network and the trained machine learning-based system comprises a trained neural network.

15. The system as claimed in claim 10, wherein the machine learning-based system comprises a neural network and the trained machine learning-based system comprises a trained neural network, and
wherein the trained neural network comprises the neural network trained using unsupervised training.

16. The system as claimed in claim 10, wherein the machine learning-based system is trained using PET data.

17. The system as claimed claim 10, wherein the machine learning-based system is trained using gated PET data.
